(19) United States
(12) Patent Application Publication
(10) Pub. No.: US 2010/0211893 A1
(43) Pub. Date: Aug. 19, 2010

(54) CROSS-BROWSER PAGE VISUALIZATION PRESENTATION

(75) Inventors: Michael C. Fanning, Redmond, WA (US); Boris Feldman, Seattle, WA (US); Steven I. Guttman, Mercer Island, WA (US); Tyler G. Simpson, Redmond, WA (US); Erik A. Saltwell, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/388,899

(22) Filed: Feb. 19, 2009

(51) Int. Cl. G06F 3/048

(52) U.S. Cl. 715/760

(57) ABSTRACT

Web developers devote significant time and resources to investigating and mitigating inconsistencies that may present when a web page is rendered across different browsers. As provided herein, a cross-browser page visualization may be presented, which comprises one or more screenshot images of a web page rendered with different browsers, coupled with underlying styling and/or Document Object Model representation data. This allows for powerful page visualization and/or feature analysis. For example, rendering inconsistencies may be easily (or even automatically) detected and/or corrected.

### BACKGROUND

Users have a variety of web browsers and respective versions of browsers to choose amongst when accessing internet resources (e.g., web pages, web applications, etc.). Different web browsers may interpret and render an internet resource differently, thus causing rendering inconsistencies. For example, one web browser may render an image within a webpage at a different position than another web browser. To make matters worse, rendering inconsistencies may be caused by differences amongst operating systems and other settings. A developer may spend significant time investigating and eliminating rendering differences between web browsers. The developer may have to render a webpage within multiple browsers, versions, and operating systems to detect rendering inconsistencies.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A technique for presenting a cross-browser page visualization is disclosed herein. User interface (UI) element reference data may be generated by aggregating a first UI element DOM representation data of a UI element of a page rendered by a first browser with a second UI element DOM representation data of the UI element of the page rendered by a second browser. Respective UI element DOM representation data may comprise, for example, a hierarchical arrangement of user interface (UI) elements and/or their respective attributes associated with rendering the page within a particular browser. The UI element reference data may comprise a correlation of UI element DOM representation data of the UI element rendered across multiple browsers. For example, the size and position of the UI element as rendered by the first browser may be correlated with the size and position of the UI element as rendered by the second browser. The UI element reference data may be used to determine a discrepancy of the UI element rendered within respective first and second browsers.

A cross-browser visualization of the page may be presented, wherein the discrepancy of the UI element may be illustrated within the cross-browser visualization. The cross-browser visualization may comprise a first screenshot of the page rendered with the first browser and a second screenshot of the page rendered with the second browser. The first UI element DOM representation data and/or the second UI element DOM representation data may be illustrated within the cross-browser visualization, the first screenshot, and/or the second screenshot. For example, the size and position of a button may be illustrated at respective pixel coordinates of the button within a screenshot of a web page rendered within a web browser. The cross-browser visualization may be presented within a side by side view mode, an overlay mode, and/or an image difference mode. Manual comparison tools, automatic analysis tools, and/or inspection tools may be presented to facilitate detection and/or correction of rendering inconsistencies of a page rendered across multiple browsers.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of presenting a cross-browser page visualization.

FIG. 2 is a component block diagram illustrating an exemplary system for presenting a cross-browser page visualization.

FIG. 3 is an illustration of an example of presenting a cross-browser visualization of a page rendered within multiple browsers.

FIG. 4 is an illustration of an example of presenting a cross-browser visualization of a page rendered within multiple browsers.

FIG. 5 is an illustration of an example of presenting a cross-browser visualization of a page rendered within multiple browsers.

FIG. 6 is an illustration of an example of presenting a cross-browser visualization of a page rendered within multiple browsers.

FIG. 7 is an illustration of an example of presenting a cross-browser visualization of a page rendered within multiple browsers.

FIG. 8 is an illustration of an example of presenting a cross-browser visualization of a page rendered within multiple browsers.

FIG. 9 is an illustration of an example of a cross-browser visualization presented within respective modes.

FIG. 10 is an illustration of an example of a cross-browser visualization presented within a development environment.

FIG. 11 is an illustration of an exemplary computer-readable medium wherein processor-executable instructions configured to embody one or more of the provisions set forth herein may be comprised.

FIG. 12 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Many internet resources (e.g., web pages) are intentionally developed and designed to run on one or more browsers and/or on different versions of the same or different browsers (e.g., browser 1, version 1.0; browser 1, version 2.0; browser 2, version 1.0) and often for multiple versions of one or more platforms (e.g., operating system 1 and operating system 2). A browser version may represent a distinct code base with its own rendering characteristics. Browser user settings and/or operating system configurations may also influence rendering. Furthermore, mark-up (e.g., source code representing a web page) may respond differently to a variety of environment conditions (e.g., via scripting machines and other dynamic HTML technologies) that may alter the final rendered version. These rendering inconsistencies may significantly complicate the task of developing internet resources that render consistently for users regardless of the web browser, operating system, and/or other variables.

A developer may devote significant time to investigate and mitigate rendering inconsistencies. For example, multiple UI elements (e.g., an image, a button, a text label, etc.) within a page may be rendered inconsistently (e.g., rendering in different positions, rendered in different sizes, etc.) across a variety of web browsers. To troubleshoot the issue, a developer may be limited to particular operating systems and/or web browser versions. For example, many operating systems and/or web browser versions may be unable to operate within the same computing environment, thus a developer may have to use multiple computing environments (e.g., multiple personal computers) to investigate rendering inconsistencies. As more web browsers and/or versions become available, the task of developing web pages that render consistently across them becomes increasingly time consuming and complicated.

Currently, web authoring tools may comprise a rendering engine configured to render a web page within a few well-established browsers. This approach does not address rendering inconsistencies due to other operating systems, browsers, etc. Another current approach is to provide a preview experience by loading a web page in one or more locally installed browsers. This approach is limited to installed browsers which may be restricted by operating system considerations and/or side-by-side considerations (e.g., a version of a web browser may not install side by side with another version) for various browsers. Yet another current approach is to send the web page to a remote server for processing. This approach may provide a diverse set of browser renderings, but may be limited to providing static images of the rendered web pages. It may be difficult to detect rendering inconsistencies between static images.

Among other things, a technique for presenting a cross-browser page visualization is provided herein. A cross-browser visualization may comprise screenshot images of a page rendered in one or more browsers. The screenshot images may be coupled with user interface (UI) element Document Object Model (DOM) representation data. For example, a cross-browser visualization may provide high-fidelity renderings coupled with underlying HTML data, CSS data, layout information, UI element attribute data, etc. The cross-browser visualization may be presented within a single environment to aid a developer in comparing, detecting, and/or correcting rendering inconsistencies. The cross-browser visualization may be presented in a variety of view modes such as side by side view mode, overlay mode, image difference mode (e.g., comparison of screenshot images using image processing algorithms).

Additional information and analysis features may be provided by aggregating UI element DOM representation data of multiple renderings. It may be appreciated that UI element DOM representation data may comprise a hierarchical arrangement of UI elements and/or their respective attributes (e.g., layout information, styling information, UI element attribute data, bounding box attributes, and/or other rendering data corresponding to UI elements rendered within a particular browser). In one example, a discrepancy of a UI element rendered across multiple browsers may be illustrated within a cross-browser visualization. In another example, UI element DOM representation data may be illustrated at respective pixel coordinates of a UI element. In yet another example, an inspection tool may highlight pixel coordinates of a UI element across multiple screenshots. Additional tools may be provided, such as grids, guidelines, nudge tools, rules, etc.

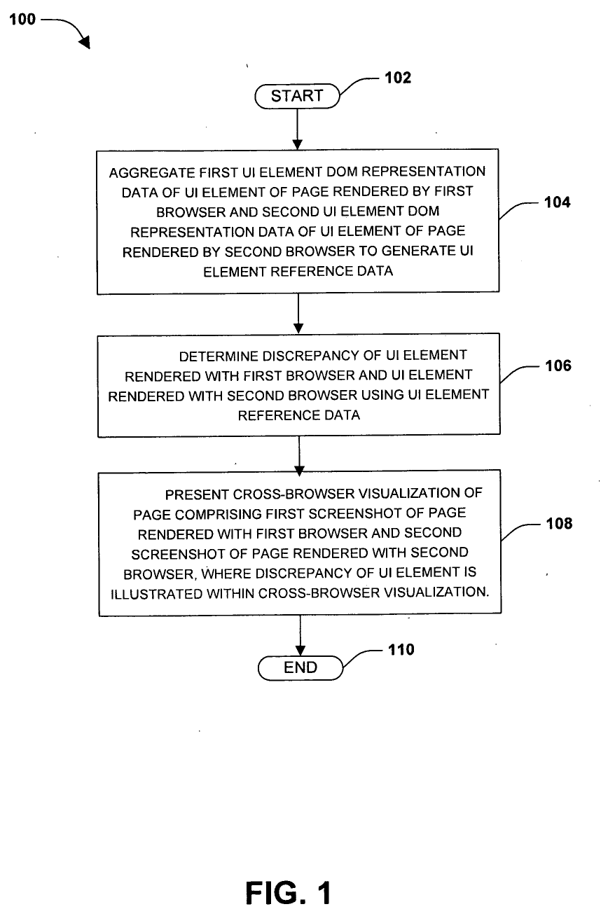

One embodiment of presenting a cross-browser page visualization is illustrated by an exemplary method 100 in FIG. 1. At 102, the method begins. At 104, UI element reference data may be generated by aggregating first UI element DOM representation data of a UI element of a page rendered by a first browser and second UI element DOM representation data of the UI element rendered by a second browser. The UI element reference data correlates UI elements across multiple browser renderings. The UI element reference data may be used to provide automatic identification of discrepancies, visual navigation of a UI element across multiple screenshot images (e.g., multiple browser renderings), and/or other analysis features. It will be appreciated that while “first” and “second” designations are used herein for different elements or components (e.g., DOM representation data, browsers and screenshots (below)), that these are merely used for clarity and ease of understanding (e.g., to differentiate and/or identify the different elements). They are not, however, meant to limit the scope of the subject matter claimed herein. That is, a limitation of a one to one (1:1) correspondence is not to be inferred. For example, a correspondence between a first and a second should not be limited to just that first and that second, but should instead generally be interpreted as a correspondence between that first and one or more seconds (e.g., a single second is merely used herein because it simplifies the discussion.)

At 106, a discrepancy of the UI element rendered within the first browser and the UI element rendered within the second browser may be determined using the UI element reference data. In one example, a webpage may comprise an image UI element. The webpage may be rendered in a first web browser and a second web browser. Respective UI element DOM representation data of the two renderings may be aggregated together to create UI element reference data. Positional layout information, for example, of the image UI element may be normalized between the two renderings within the UI element reference data. The UI element reference data may be analyzed to automatically detect rendering inconsistencies of the image UI element. For example, if the positional layout information (e.g., pixel coordinates) of the image UI element are inconsistent, then a discrepancy may be determined.

At 108, a cross-browser visualization of the page may be presented. The cross-browser visualization may comprise a first screenshot of the page rendered with the first browser and a second screenshot of the page rendered with the second browser. It may be appreciated that a screenshot of a page rendered within a browser may be associated with UI element DOM representation data of the page rendered within the browser. The discrepancy of the UI element may be illustrated within the cross-browser visualization. In one example, the UI element may be highlighted within the first screenshot and the second screenshot. In another example, the discrepancy may be automatically corrected and the illustrated discrepancy may be an illustration of the correction. In yet another example, UI element DOM representation data may be presented at respective pixel coordinates of the discrepancy. At 110, the method ends.

UI element DOM representation data may be illustrated within the cross-browser visualization and/or within one or more screenshots. For example, UI element attribute data may be presented when a corresponding UI element is selected within a screenshot. For example, layout information (e.g., margin attributes, padding attributes, outline of UI element bounding box, border attributes, etc.) of a selected UI element may be illustrated at respective pixel coordinates of the selected UI element. This may allow a developer to visually compare layout information of a selected UI element across multiple screenshots. Additionally, source code corresponding to a UI element selected within a screenshot may be presented. This may allow a developer to quickly access the original source code of a UI element to correct rendering inconsistencies.

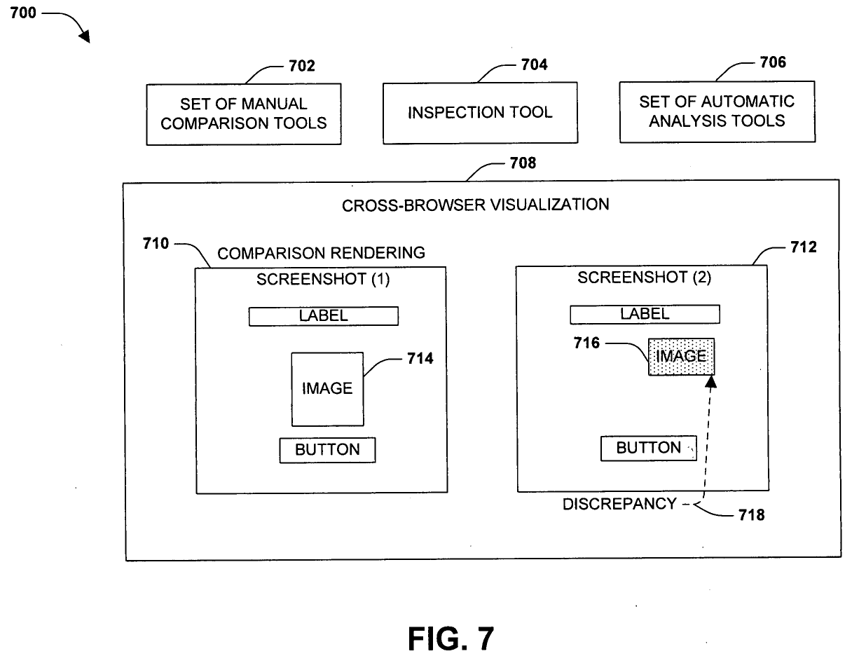

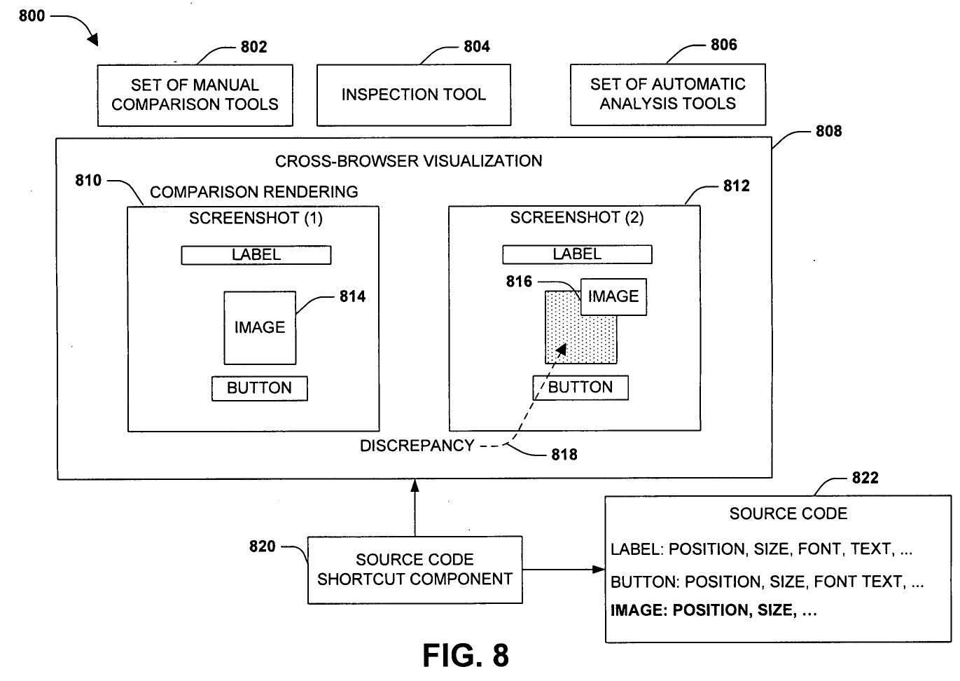

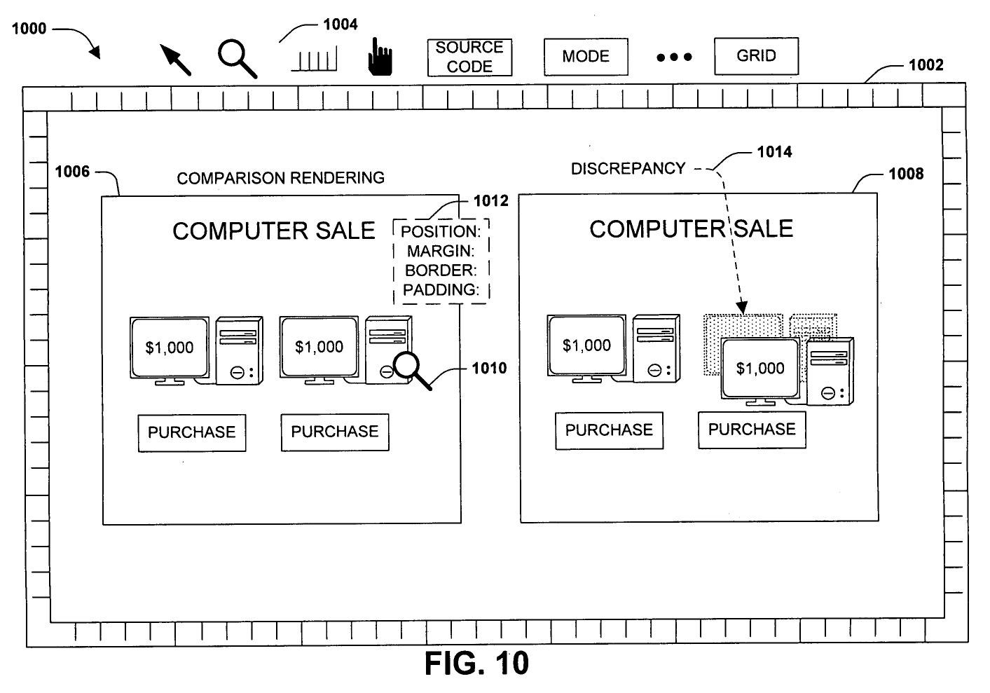

The cross-browser visualization may be presented within a single development environment. Unlike current techniques that may only provide static screenshots of page renderings, advanced analysis tools may be provided based upon the UI element DOM representation data and the UI element reference data. The analysis tools (e.g., FIG. 10) may aid a developer in comparing renderings and/or detecting and correcting rendering inconsistencies. In one example, a set of pixel coordinates corresponding to a selected UI element may be highlighted across multiple screenshots within a cross-browser visualization (e.g., FIG. 8). In another example, a selected UI element may be highlighted across multiple screenshots within a cross-browser visualization (e.g., FIG. 7). In yet another example, a developer may use an inspection tool to select a UI element within a screenshot. UI element DOM representation data (e.g., styling and layout information) and/or automatically detected discrepancies may be presented.

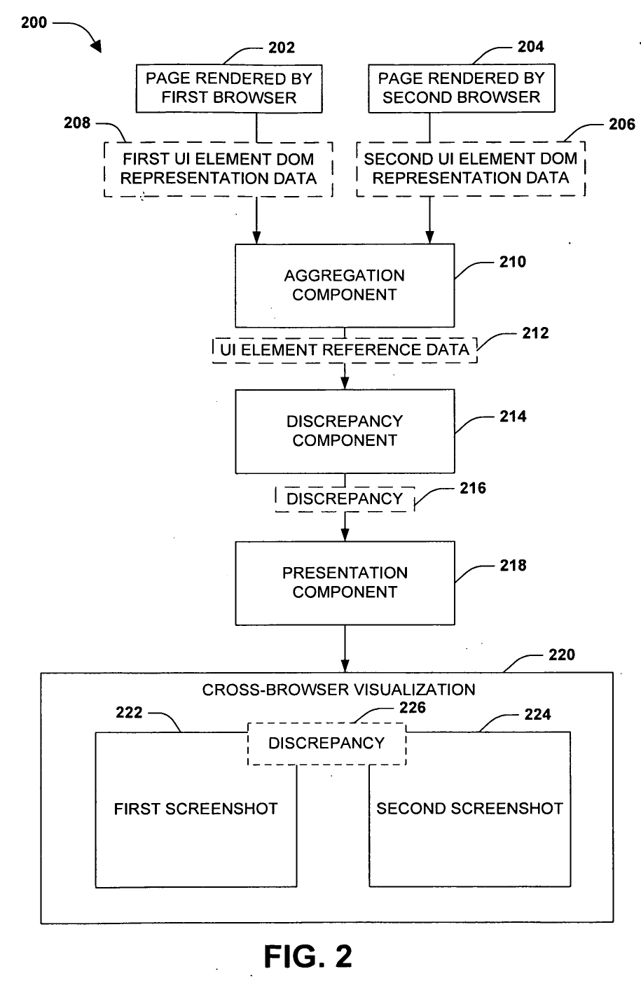

FIG. 2 illustrates an example 200 of a system configured for presenting a cross-browser page visualization. The system may comprise an aggregation component 210, a discrepancy component 214, and/or a presentation component 218. The aggregation component 210 may be configured to generate UI element reference data 212 by aggregating a first UI element DOM representation data 208 of a UI element of a page rendered by a first browser 202 with second UI element DOM representation data 206 of the UI element of the page rendered by a second browser 204. For example, margin attributes of a UI element rendered in respective browsers may be correlated together. It may be appreciated that multiple UI elements may be described within UI element DOM representation data (e.g., the rendered page comprises multiple UI elements), thus UI element reference data may be created corresponding to multiple UI elements.

The discrepancy component 214 may be configured to determine a discrepancy 216 of the UI element rendered with the first browser and the UI element rendered with the second browser using the UI element reference data 212. For example, the x and y offsets of the UI element rendered within the first browser may be inconsistent with the x and y offsets of the UI element rendered within the second browser. The discrepancy may be determined by analyzing the UI element reference data 212 because the x and y offsets of respective first and second rendering are correlated together.

The presentation component 218 may be configured to present a cross-browser visualization 220 of the page renderings. The cross-browser visualization 220 may comprise a first screenshot 222 of the page rendered within the first browser and a second screenshot 224 of the page rendered with the second browser. The presentation component 218 may be configured to illustrate the discrepancy 226 and/or UI element DOM representation data of the UI element within the first screenshot 222, second screenshot 224, and/or the cross-browser visualization 220.

The presentation component 218 may be configured to present the cross-browser page visualization within one or more visualizations modes. For example the first screenshot 222 and the second screenshot 224 may be presented in a side by side view mode. In another example, the first screenshot 222 may overlay the second screenshot 224 in an overlay mode. In yet another example, an image difference may be presented based upon an image processing algorithm (e.g., rgb=r1−r0, g1−g0, b1−b0) comparing the first screenshot 222 and the second screenshot 224. The presentation component may be configured to present a static design image representing the page. This may allow a user to compare the page rendered in multiple browsers to a static design image (e.g., a mockup or design template of the page).

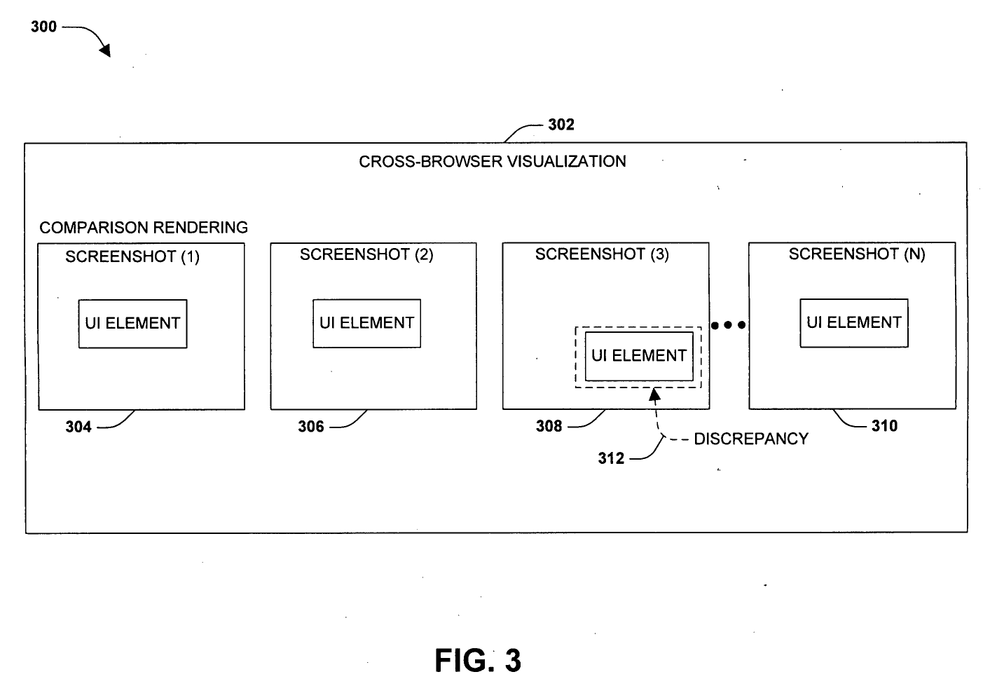

FIG. 3 illustrates an example 300 of presenting a cross-browser visualization of a page rendered within multiple browsers. In example 300, a cross-browser visualization 302 may be presented. The cross-browser visualization 302 may comprise a screenshot (1) 304, a screenshot (2) 306, a screenshot (3) 308, and/or other screenshots (e.g., screenshot (N) 310). Respective screenshots may represent a snapshot image of a page (e.g., a web page) rendered within a particular web browser. The page may comprise a UI element (e.g., an image). The cross-browser visualization 302 allows a developer to compare and analyze the page rendered within desired browsers. A comparison rendering (e.g., the screenshot (1) 304) may be designated by the developer as a desired rendering, to which other screenshots may be compared for inconsistencies. It will be appreciated that the comparison rendering may, for example, be a browser that was initially used to develop and test the page.

The cross-browser visualization 302 may provide the developer with screenshot images coupled with respective underlying DOM and/or styling information. For example, UI element reference data may be analyzed to determine a discrepancy 312 (e.g., inconsistency of layout information between a comparison rendering and one or more screenshots). In one example, the discrepancy 312 may be illustrated by highlighting the UI element within the screenshot (3) 308 comprising the inconsistency. In another example, inconsistent UI element DOM representation data (e.g., x and y offsets) may be illustrated. In yet another example, the inconsistency may be automatically corrected and the discrepancy 312 may comprise a notification of the automatic correction.

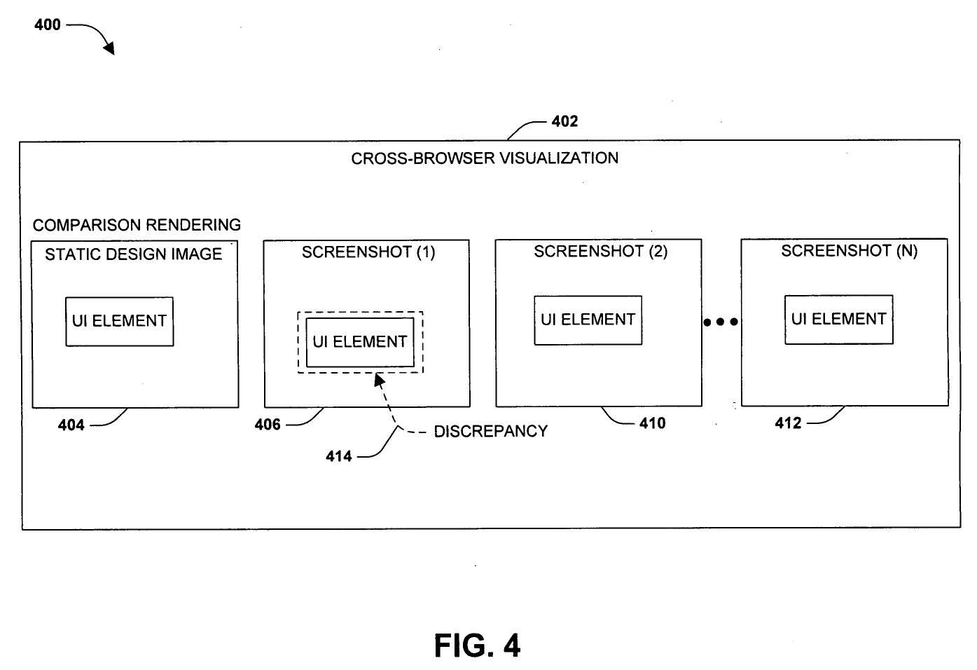

FIG. 4 illustrates an example 400 of presenting a cross-browser visualization of a page rendered within multiple browsers. In example 400, a cross-browser visualization 402 may be presented. The cross-browser visualization 402 may comprise a static design image 404, a screenshot (1) 406, a screenshot (2) 410, and/or other screenshots (e.g., screenshot (N) 412). The static design image 404 may be designated as a comparison rendering. For example, a developer may associate a design mockup image of a web page, wherein the design mockup image represents a desirable rendering of the web page. Respective screenshots may be manually compared with the static design image 404. For example, a user may highlight a UI element within the screenshot (1), and the UI element may resultantly also be highlighted within the static design image 404. This may allow the user to manually determine a discrepancy 414. It will be appreciated that a static design image may not comprise DOM representation data and/or screenshot data. However, UI elements may be illustrated within the static design image in response to a user selecting UI elements within the cross-browser visualization 402.

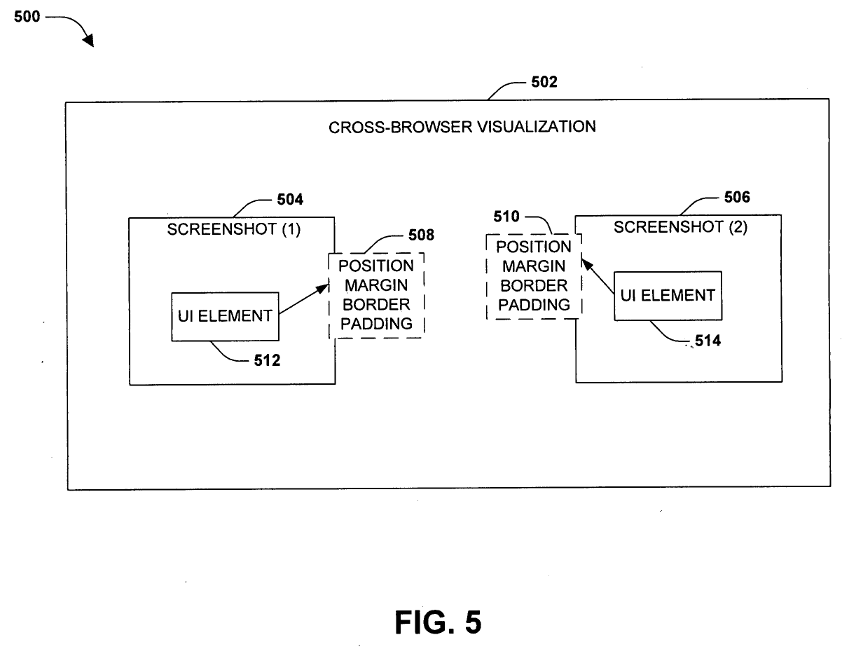

FIG. 5 illustrates an example 500 of presenting a cross-browser visualization of a page rendered within multiple browsers. In example 500, a cross-browser visualization 502 may be presented. The cross-browser visualization 502 may comprise a screenshot (1) 504 of a page rendered by a first browser and a screenshot (2) 506 of the page rendered by a second browser. The page may comprise a UI element rendered as a UI element 512 by the first browser (screenshot (1) 504 comprises the rendering of the UI element) and rendered as a UI element 514 by the second browser (screenshot (2) 506 comprises the rendering of the UI element).

UI element DOM representation data of the UI element as rendered by respective browsers may be illustrated within the cross-browser visualization 502, screenshot (1) 504, and/or screenshot (2) 506. For example, layout information 508 (e.g., position, margin, border, padding, size, width, height, stacking order, etc.) of the UI element 512 rendered by the first browser may be presented at respective pixel coordinates of the UI element 512 in the screenshot (1) 504. The layout information 510 of the UI element 514 rendered by the second browser may be presented at respective pixel coordinates of the UI element 514 in the screenshot (2) 506. It may be appreciated that a screenshot may be coupled with underlying UI element DOM representation data, thus allowing for additional rendering information to be illustrated.

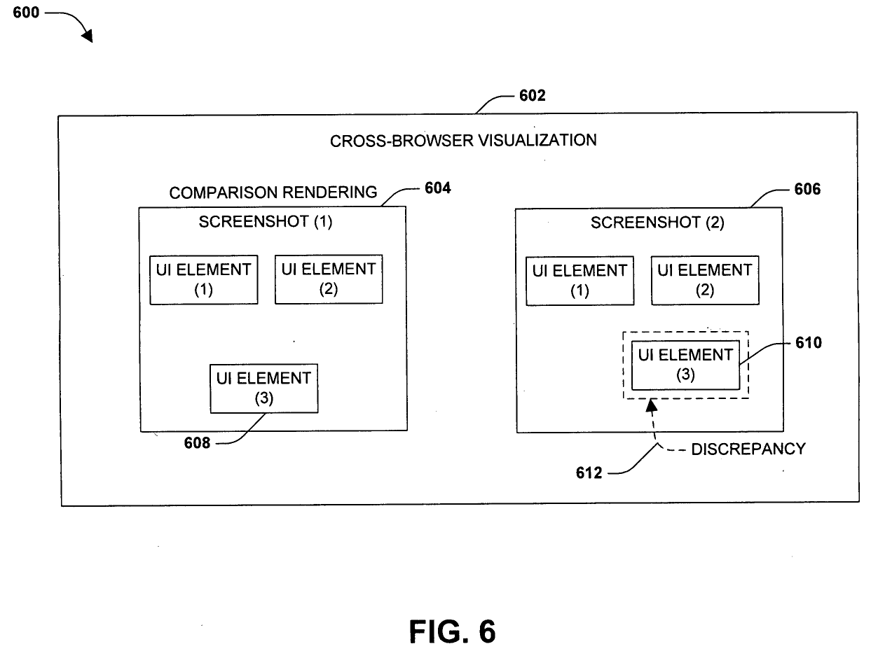

FIG. 6 illustrates an example 600 of presenting a cross-browser visualization of a page rendered within multiple browsers. In example 600, a cross-browser visualization 602 may be presented. The cross-browser visualization 602 may comprise a screenshot (1) 604 of a page rendered by a first browser and a screenshot (2) 606 of the page rendered by a second browser. The page may comprise multiple UI elements (e.g., a UI element (1), a UI element (2), a UI element (3) 608 as rendered by the first browser, and/or a UI element (3) 610 as rendered by the second browser) that may be rendered by respective first and second browsers.

UI element reference data may be analyzed to determine a discrepancy of a UI element rendered across one or more browsers. For example, rendering information of the UI element (3) 608 as rendered by the first browser may be compared with rendering information of the UI element (3) 610 as rendered by the second browser. This comparison may be accomplished by analyzing correlated UI element DOM representation data within the UI element reference data. A discrepancy may also be determined by comparing screenshots and/or respective DOM representation data (e.g., utilizing an image comparison algorithm within an image difference mode).

Discrepancies between renderings may be illustrated in the cross-browser visualization 602, the screenshot (1), and/or the screenshot (2). For example, a discrepancy 612 in rendering may be detected with respect to UI element (3) as rendered by respective first and second browsers. The discrepancy 612 may be based upon an inconsistency between x and y offsets of the UI element (3) 610 and x and y offsets of the UI element (3) 608.

FIG. 7 is an illustration of an example 700 of presenting a cross-browser visualization of a page rendered within multiple browsers. In example 700, a cross-browser visualization 708 may be presented within a development environment. Within the development environment, a set of manual comparison tools 702, an inspection tool 704, and/or a set of automatic analysis tools 706 may be presented. The cross-browser visualization 708 may comprise a screenshot (1) 710 of a page rendered by a first browser and a screenshot (2) 712 of the page rendered by a second browser. The page may comprise multiple UI elements (e.g., a label, a button, an image 714 as rendered by the first browser, and/or an image 716 as rendered by the second browser) that may be rendered by respective first and second browsers. Screenshot (1) 710 may be designated as a comparison rendering (e.g., designate a comparison rendering using the inspection tool 704).

The inspection tool 704 may allow a developer to highlight a UI element within a screenshot. For example, a developer may highlight the image 714 within the screenshot (1) 710. Using UI element reference data, the image 716 within the screenshot (2) 712 may be highlighted. This may aid the developer in comparing the image rendered within respective screenshots for discrepancies. A discrepancy 718 may be automatically determined and/or illustrated within the cross-browser visualization 708, screenshot (1) 710, and/or screenshot (2) 712. For example, the set of automatic analysis tools 706 may automatically determine and/or illustrate discrepancies (e.g., highlight the UI element having inconsistent layout information, provide textual feedback, etc.). One example of an automatic analysis would be to highlight those elements that have respective (calculated) widths that are different between different renderings. The set of manual comparison tools 702 (e.g., present a grid, ruler, nudge tool, etc.) may allow the user to manually manipulate the cross-browser visualization 708 and/or respective screenshots to visually interrogate the renderings to detection discrepancies.

FIG. 8 is an illustration of an example 800 of presenting a cross-browser visualization of a page rendered within multiple browsers. In example 800, a cross-browser visualization 808 may be presented within a development environment. Within the development environment, a set of manual comparison tools 802, an inspection tool 804, and/or a set of automatic analysis tools 806 may be presented. The cross-browser visualization 808 may comprise a screenshot (1) 810 of a page rendered by a first browser and a screenshot (2) 812 of the page rendered by a second browser. The page may comprise multiple UI elements (e.g., a label, a button, an image 814 as rendered by the first browser, and/or an image 816 as rendered by the second browser) that may be rendered by respective first and second browsers. Screenshot (1) 810 may be designated as a comparison rendering.

In example 800, a discrepancy 818 between the image 816 as rendered by the second browser and the image 814 as rendered by the first browser may be automatically determined. The discrepancy 818 may be illustrated by highlighting pixel coordinates in screenshot (2) 812 corresponding to pixel coordinates of the image 814 as rendered in the comparison rendering. In example 800, a source code shortcut component 820 may be configured to present source code 822 corresponding to a selected UI element (e.g., the image 816). Additionally, the cross-browser visualization 808 may, for example, be linked to the actual original source code within an editing environment used to create/alter the page source. This allows changes to be made and propagated back to a browser rendering tool for subsequent rendering. It may be appreciated that the source code 822 may correspond to original source code of the page.

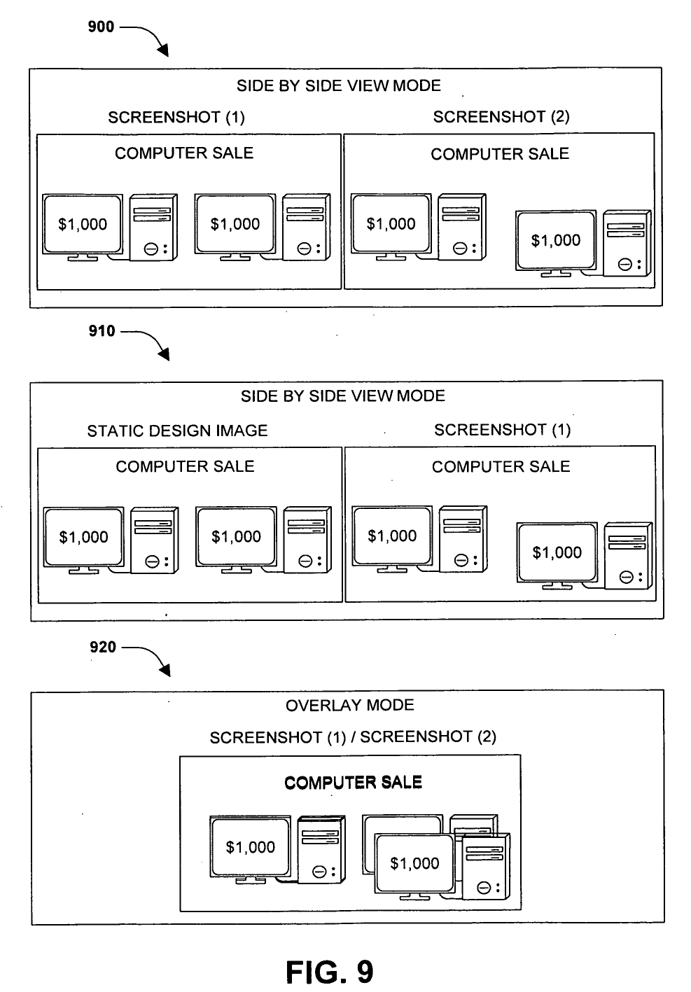

FIG. 9 is an illustration of an example 900, 910, and 920 of a cross-browser visualization presented within respective modes. In example 900, a cross-browser visualization may be presented in a side by side view mode. The cross-browser visualization may comprise a screenshot (1) presented side by side with a screenshot (2). In example 910, a cross-browser visualization may be presented in a side by side view mode. The cross-browser visualization may comprise a static design image presented side by side with a screenshot (1). In example 920, a cross-browser visualization may be presented in an overlay mode. The cross-browser visualization may comprise a screenshot (1) that overlays a screenshot (2). It will be appreciated that the opacity of the respective screenshots may be adjusted so that discrepancies can be more readily ascertained, or otherwise made apparent. It may be appreciated that a cross-browser visualization may be presented in a variety of ways. For example, a developer may choose a manual view mode or select from a set of predefined view modes.

FIG. 10 is an illustration of an example 1000 of a cross-browser visualization presented within a development environment. In example 1000, a cross-browser visualization may be presented. The cross-browser visualization may comprise a first screenshot 1006 of a computer store web page rendered within a first browser and a second screenshot 1008 of the computer store web page rendered in a second browser. The first screenshot 1006 may be designated as a comparison rendering.

A set of tools 1004 may be presented within the development environment. The set of tools 1004 may comprise, for example, an inspection tool, a nudge tool, a guide, a ruler, a source code shortcut, a mode change button, and/or other automatic or manual tools. For example, a ruler 1002 may be associated with one or more screenshots within the cross-browser visualization. An inspection tool 1010 may be used to interrogate UI elements within one or more screenshots. For example, the inspection tool 1010 may be used to interrogate a compute image UI element for UI element DOM representation data 1012 (e.g., position, margin, border, padding, and/or other attributes.). A nudge tool may allow a developer to align pages areas on multiple renderings to a common origin to perform accurate measurement. Grids, guides, and rulers may allow the developer to measure and/or quantify differences between renderings. Automatic analysis tools may determine discrepancies (e.g., a discrepancy 1014 of a computer image UI element) between renderings. These tools may aid a developer in comparing, detecting, and/or correcting rendering inconsistencies.

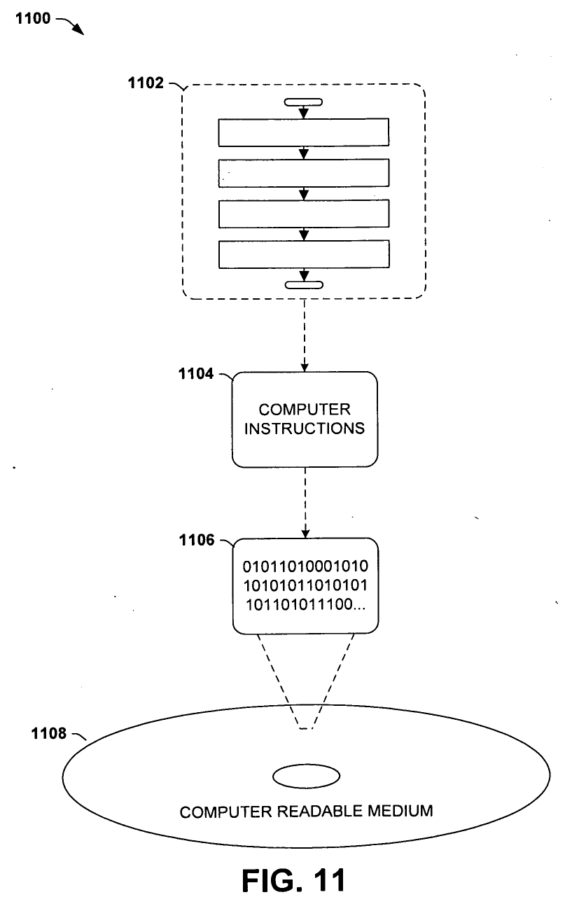

Still another embodiment involves a computer-readable medium comprising processor-executable instructions configured to implement one or more of the techniques presented herein. An exemplary computer-readable medium that may be devised in these ways is illustrated in FIG. 11, wherein the implementation 1100 comprises a computer-readable medium 1108 (e.g., a CD-R, DVD-R, or a platter of a hard disk drive), on which is encoded computer-readable data 1106. This computer-readable data 1106 in turn comprises a set of computer instructions 1104 configured to operate according to one or more of the principles set forth herein. In one such embodiment 1100, the set of computer instructions 1104 may be configured to perform a method 1102, such as the exemplary method 110 of FIG. 1, for example. In another such embodiment, the set of computer instructions 1104 may be configured to implement a system, such as the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

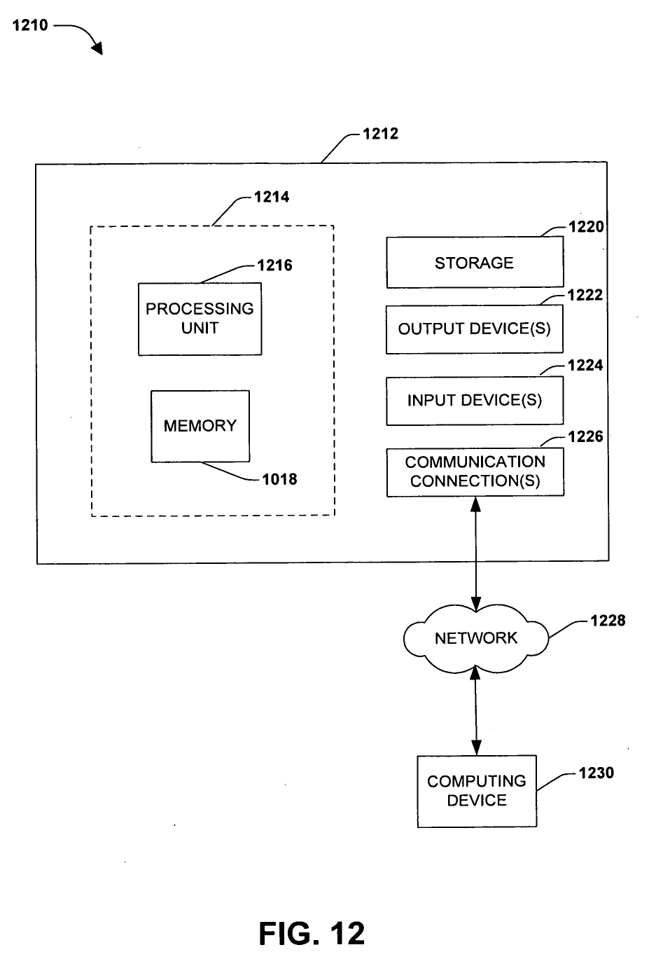

FIG. 12 and the following discussion provide a brief, general description of a suitable computing environment to implement embodiments of one or more of the provisions set forth herein. The operating environment of FIG. 12 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 12 illustrates an example of a system 1210 comprising a computing device 1212 configured to implement one or more embodiments provided herein. In one configuration, computing device 1212 includes at least one processing unit 1216 and memory 1218. Depending on the exact configuration and type of computing device, memory 1218 may be volatile (such as RAM, for example), non-volatile (such as ROM, flash memory, etc., for example) or some combination of the two. This configuration is illustrated in FIG. 12 by dashed line 1214.

In other embodiments, device 1212 may include additional features and/or functionality. For example, device 1212 may also include additional storage (e.g., removable and/or non-removable) including, but not limited to, magnetic storage, optical storage, and the like. Such additional storage is illustrated in FIG. 12 by storage 1220. In one embodiment, computer readable instructions to implement one or more embodiments provided herein may be in storage 1220. Storage 1220 may also store other computer readable instructions to implement an operating system, an application program, and the like. Computer readable instructions may be loaded in memory 1218 for execution by processing unit 1216, for example.

The term “computer readable media” as used herein includes computer storage media. Computer storage media includes volatile and nonvolatile, removable and non-removable media implemented in any method or technology for storage of information such as computer readable instructions or other data. Memory 1218 and storage 1220 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1212. Any such computer storage media may be part of device 1212.

Device 1212 may also include communication connection(s) 1226 that allows device 1212 to communicate with other devices. Communication connection(s) 1226 may include, but is not limited to, a modem, a Network Interface Card (NIC), an integrated network interface, a radio frequency transmitter/receiver, an infrared port, a USB connection, or other interfaces for connecting computing device 1212 to other computing devices. Communication connection(s) 1226 may include a wired connection or a wireless connection. Communication connection(s) 1226 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1212 may include input device(s) 1224 such as keyboard, mouse, pen, voice input device, touch input device, infrared cameras, video input devices, and/or any other input device. Output device(s) 1222 such as one or more displays, speakers, printers, and/or any other output device may also be included in device 1212. Input device(s) 1224 and output device(s) 1222 may be connected to device 1212 via a wired connection, wireless connection, or any combination thereof. In one embodiment, an input device or an output device from another computing device may be used as input device(s) 1224 or output device(s) 1222 for computing device 1212.

Components of computing device 1212 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1212 may be interconnected by a network. For example, memory 1218 may be comprised of multiple physical memory units located in different physical locations interconnected by a network.

Those skilled in the art will realize that storage devices utilized to store computer readable instructions may be distributed across a network. For example, a computing device 1230 accessible via network 1228 may store computer readable instructions to implement one or more embodiments provided herein. Computing device 1212 may access computing device 1230 and download a part or all of the computer readable instructions for execution. Alternatively, computing device 1212 may download pieces of the computer readable instructions, as needed, or some instructions may be executed at computing device 1212 and some at computing device 1230.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for presenting a cross-browser page visualization comprising:
aggregating first UI element DOM representation data of a UI element of a page rendered by a first browser and second UI element DOM representation data of the UI element of the page rendered by a second browser to generate UI element reference data;
determining a discrepancy of the UI element rendered with the first browser and the UI element rendered with the second browser using the UI element reference data; and
presenting a cross-browser visualization of the page comprising a first screenshot of the page rendered with the first browser and a second screenshot of the page rendered with the second browser, where the discrepancy of the UI element is illustrated within the cross-browser visualization.

2. The method of claim 1, comprising:
illustrating at least one of the first UI element DOM representation data and the second UI element DOM representation data within one or more of the first and second screenshots.

3. The method of claim 2, the illustrated UI element DOM representation data comprising at least one of:
a margin attribute;
a size attribute;
a padding attribute;
an outline of UI element bounding box;
a border attribute; and
a position attribute.

4. The method of claim 1, the presenting comprising:
presenting the cross-browser visualization within a side by side view mode.

5. The method of claim 1, the presenting comprising:
presenting the cross-browser visualization within an overlay view mode.

6. The method of claim 1, comprising:
presenting source code corresponding to the UI element, when the UI element is selected in one or more of the first and second screenshots.

7. The method of claim 1, comprising:
highlighting the UI element within the second screenshot based upon the UI element reference data, when the UI element is selected in the first screenshot.

8. The method of claim 1, comprising:
highlighting a portion of the second screenshot corresponding to a portion of the first screenshot comprising the UI element, when the UI element is selected in the first screenshot.

9. The method of claim 1, comprising:
presenting UI element attribute data in a screenshot when the UI element is selected in a screenshot.

10. The method of claim 1, comprising:
presenting a set of manual comparison tools comprising at least one of the following:
a grid;
a nudge tool;
a guide; and
a ruler.

11. A system for presenting a cross-browser page visualization comprising:
an aggregation component configured to:
aggregate first UI element DOM representation data of a UI element of a page rendered by a first browser and second UI element DOM representation data of the UI element of the page rendered by a second browser to generate UI element reference data;
an discrepancy component configured to:
determine a discrepancy of the UI element rendered with the first browser and the UI element rendered with the second browser using the UI element reference data; and
a presentation component configured to:
present a cross-browser visualization of the page comprising:
a first screenshot of the page rendered with the first browser; and
a second screenshot of the page rendered with the second browser; and
illustrate the discrepancy of the UI element within the cross-browser visualization.

12. The system of claim 11, the presentation component configured to illustrate at least one of the first UI element DOM representation data and the second UI element DOM representation data within one or more of the first and second screenshots.

13. The system of claim 11, the presentation component configured to present a static design image representing the page.

14. The system of claim 11, comprising:
a source code shortcut component configured to correlate the cross-browser visualization with original source code within an editing environment.

15. The system of claim 11, the presentation component configured to present the cross-browser page visualization within at least one of:
a side by side view mode;
an overlay mode; and
an image difference mode.

16. The system of claim 11, comprising:
an inspection tool configured to highlight the UI element within the second screenshot based upon the UI element reference data, when the UI element is selected in the first screenshot.

17. The system of claim 16, the inspection tool configured to highlight a portion of the second screenshot corresponding to a portion of the first screenshot comprising the UI element, when the UI element is selected in the first screenshot.

18. The system of claim 16, the inspection tool configured to designate a comparison rendering based upon a selection of a screenshot within the cross-browser visualization.

19. The system of claim 11, comprising:
a set of automatic analysis tools configured to illustrate UI element reference data corresponding to the cross-browser visualization; and
a set of manual comparison tools comprising:
a grid;
a nudge tool;
a guide; and
a ruler.

20. A system for presenting a cross-browser page visualization comprising:
an aggregation component configured to:
aggregate first UI element DOM representation data of a UI element of a page rendered by a first browser and second UI element DOM representation data of the UI element of the page rendered by a second browser to generate UI element reference data;
an discrepancy component configured to:
determine a discrepancy of the UI element rendered with the first browser and the UI element rendered with the second browser using the UI element reference data;
a presentation component configured to:
present a cross-browser visualization of the page comprising:
a first screenshot of the page rendered with the first browser; and
a second screenshot of the page rendered with the second browser;
illustrate the discrepancy of the UI element within the cross-browser visualization; and
illustrate at least one of the first UI element DOM representation data and the second UI element DOM representation data within one or more of the first and second screenshots; and
a source code shortcut component configured to present source code corresponding to the UI element, when the UI element is selected in one or more of the first and second screenshots.
